(19) United States
(12) Patent Application Publication
(10) Pub. No.: US 2015/0264603 A1
(43) Pub. Date: Sep. 17, 2015

(54) METHODS AND APPARATUS FOR HANDLING TIME-TO-TRIGGER DURING INTRA-RAT CELL RESELECTION AND HANDOVER

(71) Applicant: QUALCOMM Incorporated, San Diego, CA (US)

(72) Inventors: Ming Yang, San Diego, CA (US); Zhengming Li, San Diego, CA (US); Qingxin Chen, Del Mar, CA (US); Tom Chin, San Diego, CA (US); Shaohong Qu, San Diego, CA (US); Guangming Shi, San Diego, CA (US)

(73) Assignee: QUALCOMM Incorporated, San Diego, CA (US)

(21) Appl. No.: 14/212,402

(22) Filed: Mar. 14, 2014

(51) Int. Cl. H04W 36/00

(52) U.S. Cl. CPC H04W 36/0022; H04W 36/0061

(57) ABSTRACT

In an aspect of the disclosure, a method of wireless communication is provided. The method may include starting a first timer for changing to a first network cell with a first radio access technology (RAT) and starting a second timer for changing to a second network cell with a second RAT. Further, the method may include changing to the first network cell when the first timer expires. The method may also include determining that the second network cell satisfies a cell change condition and continuing to run the second timer after the change to the first network cell in response to the second network cell satisfying the cell change condition. The method may further include changing to the second network cell after starting a third timer for a third network cell with the first RAT, a duration of the second timer being longer than a duration of the third timer.

### BACKGROUND

Aspects of the present disclosure relate generally to wireless communication systems, and more particularly, to cell reselection and handover in mobile networks.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication is provided. The method may include starting a first timer for changing to a first network cell with a first radio access technology (RAT) and starting a second timer for changing to a second network cell with a second RAT. Further, the method may include changing to the first network cell when the first timer expires. The method can also include determining that the second network cell satisfies a cell change condition and continuing to run the second timer after the change to the first network cell in response to the second network cell satisfying the cell change condition.

Another aspect relates to an apparatus for wireless communication. The apparatus may comprise means for starting a first timer for changing to a first network cell with a first RAT and means for starting a second timer for changing to a second network cell with a second RAT. The apparatus may further comprise means for changing to the first network cell when the first timer expires. In addition, the apparatus may comprise: means for determining that the second network cell satisfies a cell change condition; and means for continuing to run the second timer after the change to the first network cell in response to the second network cell satisfying the cell change condition.

Yet another aspect relates to an apparatus for wireless communication. The apparatus can include at least one processor configured to start a first timer for changing to a first network cell with a first RAT and start a second timer for changing to a second network cell with a second RAT. The processor may be further configured to change to the first network cell when the first timer expires, determine that the second network cell satisfies a cell change condition, and continue to run the second timer after the change to the first network cell in response to the second network cell satisfying the cell change condition.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an aspect of a system including a UE having a communication manager component as described herein.

FIG. 2 is a flowchart illustrating a method of cell selection.

FIG. 3 is a flowchart illustrating another method of cell selection.

FIG. 4 is a timing diagram illustrating a high mobility scenario.

FIG. 5 is a timing diagram illustrating a ping-pong scenario.

FIG. 6 is a block diagram conceptually illustrating an example of a telecommunications system.

FIG. 7 is a block diagram conceptually illustrating an example of a hardware implementation for an apparatus employing a processing system.

FIG. 8 is a block diagram conceptually illustrating an access network.

FIG. 9 is a block diagram conceptually illustrating an example of a Node B in communication with a UE in a telecommunications system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

According to the present apparatus and methods, a user equipment (UE) may, during a handover or cell reselection, selectively continue running a timer for a cell when the UE changes to a new cell based on a cell change condition of the new cell. In other words, the UE may continue to run the timer for changing to a cell even though the UE has recently changed cells. The decision to continue running the timer may be based on a cell change condition provided by the new cell and evaluated by the UE. Accordingly, the timer may start running according to one condition, but continue to run based on a second condition. Continuing to run a timer may allow the timer for a higher priority or higher ranked inter-RAT cell to expire and initiate a change to the cell despite frequent changes in the rankings of other cells for the current RAT. For example, continuing to run a timer may allow the UE to perform an inter-RAT change in a high mobility or ping-pong scenario. In a high-mobility scenario, frequent changing of intra-frequency cells may result in delaying or preventing a handover or reselection to a higher priority inter-RAT cell. Similarly, in a ping-pong scenario, bouncing back and forth between two cells may result in delaying or preventing a handover or reselection to a higher priority inter-RAT cell.

As a result, the present apparatus and methods may enable the UE to more quickly change to a different RAT type that provides improved quality and thereby improve the user experience.

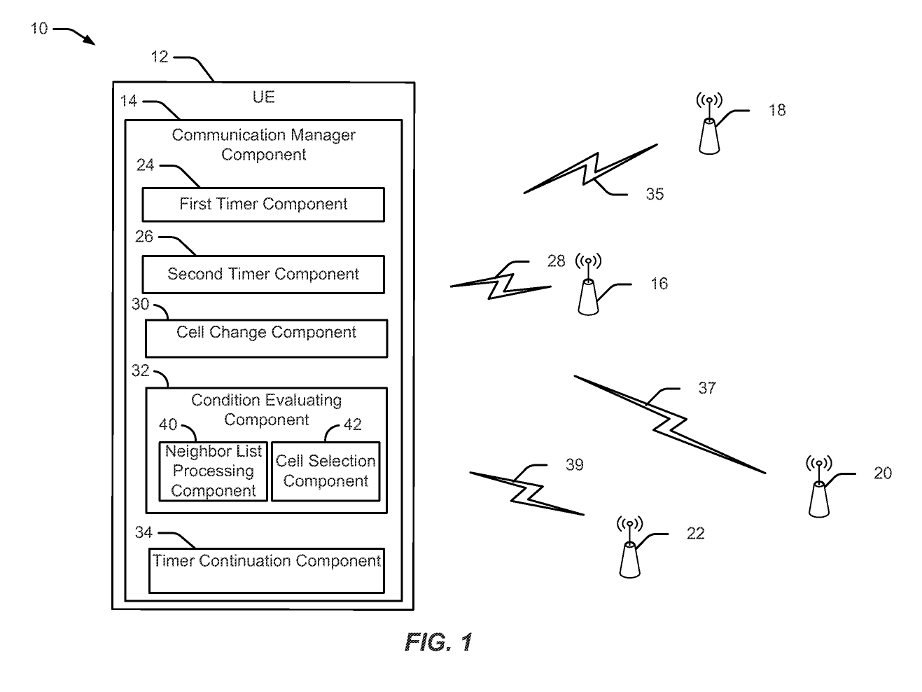

Referring to FIG. 1, in an aspect, a wireless communication system 10 includes a UE 12 having a communication manager component 14 configured to efficiently perform management of timers during cell reselection or handover. For example, communication manager component 14 is configured to selectively continue a second timer component 26 for an inter-RAT cell 22 even after a change occurs from a previous serving cell 16 to an intra-frequency cell 18. The communication manager component 14 may continue to run the second timer component 26 after the change when the inter-RAT cell 22 satisfies a cell change condition. Otherwise, when the cell change condition is not satisfied, the second timer component 26 may be reset at the time of the change. In these aspects, previous serving cell 16, intra-frequency cell 18, inter-frequency cell 20, and inter-RAT cell 22, each may operate according to any radio access technology (RAT) standard, which may be the same RAT standard or different RAT standards for each of the respective cells. For instance, in one use case that should not be construed as limiting, previous cell 16 and intra-frequency cell 18 may be operating according to TD-SCDMA, and each of inter-frequency cell 20, and inter-RAT cell 22 may be operating according to one of WCDMA, GSM, and LTE.

In addition to the second timer component 26 described above, the communications manager component 14 may include a first timer component 24, a cell change component 30, a condition evaluating component 32, and a timer continuation component 34.

First timer component 24 and second timer component 26 may each be a timer or means configured to measure, identify, and/or track a time period. For example, a timer component may be a circuit configured to count a number of clock pulses or similar electronic signals in order to measure, identify, and/or track a length of time associated with a particular activity, function, or operation. As another example, a timer component may be a memory configured to store a length, a start time, or a stop time. First timer component 24 and second timer component 26 may measure time periods for delaying an action until the time period expires. In particular, first timer component 24 may measure a time for delaying sending a report indicating that a first cell has satisfied a cell change criteria. Similarly, second timer component 26 may measure a time for delaying sending a report indicating that a second cell has satisfied a cell change criteria. A timer component 24, 26 may have a duration, that is, a length of the time period. A timer component 24, 26 may count up toward an expiration time or count down to expiration.

The cell change component 30 may include means or be configured to perform a cell change procedure according to one or more RAT standards. In a handover procedure, the cell change component 30 may send a measurement report to the network indicating that a neighbor cell has satisfied a cell change condition. The cell change component 30 may use the timer component 24 as a time-to-trigger (TTT) timer for the neighbor cell when the neighbor cell satisfies a cell change condition or an event reporting condition. A TTT timer may ensure that the relevant condition is satisfied for a period of time before the measurement report is sent in order to ensure stability of the measurements. The network may then handover the UE 12 based on the measurement report. In a reselection procedure, the cell change component 30 of an idle UE 12 may select a different cell to camp on based on measured quantities. The cell the cell change component 30 may use the timer component 24 as a reselection timer (T-reselection) for a neighbor cell when the neighbor cell satisfies a cell change condition or an event reporting condition. The T-reselection timer may ensure that the relevant condition is satisfied for a period of time before the measurement report is sent in order to ensure stability of the measurements.

The condition evaluating component 32 may include means or be configured to determine whether a cell, such as cell 22, satisfies a cell change condition. The cell change condition may be based on a RAT type for the cell 22. The condition evaluating component 32 may include a neighbor list processing component 40 and a cell selection component 42.

The neighbor list processing component 40 may include means or be configured to receive a neighbor cell list (also referred to simply as a neighbor list) from a current serving cell 16. The neighbor list processing component 40 may receive the neighbor list during a handover or reselection process when a new cell becomes the serving cell. The neighbor list may define the neighboring cells of the serving cell. The neighbor list may be included in a measurement control message provided by the network from a current serving cell 16. The neighbor list may be, for example, a CELL_INFO_LIST defined according to a specification for a current RAT type. The neighbor list processing component 40 may determine additional information regarding the cells included on the neighbor list. For example, the neighbor list may include a RAT type and a frequency for one or more of the neighbor cells included in the neighbor list. The neighbor list processing component 40 may then analyze received pilot channels to determine a corresponding cell identifier (ID) for the neighbor cell. The neighbor list processing component 40 may also determine whether any cells in a new neighbor list are common neighbor cells with a previous neighbor list. For example, the neighbor list processing component 40 may match a cell ID, frequency, and/or RAT type of a previous neighbor cell with a member of the new neighbor list to determine that the cells are common neighbor cells.

The cell selection component 42 may be configured to select a new cell for a handover or reselection procedure. The cell selection component 42 may select a new cell based on a cell change criteria. The cell change criteria may be provided by the current serving cell in a measurement control message. The cell change criteria may be based on characteristics of the current serving cell and a candidate neighbor cell. The cell change criteria may vary depending on whether the potential change between cells is an intra-frequency change, inter-frequency change, or inter-RAT change. For an inter-RAT change, each RAT type may have a priority value. A cell change condition may be satisfied when the candidate cell has a higher priority than the current serving cell. Cell rankings may also be used in cell change conditions. The neighbor cells may be ranked against each other and the current serving cell based on one or more measurement quantities. A cell change condition may be satisfied when a new cell outranks the other cells (e.g., when one or more measurements quantities of the new cell are better than the corresponding measurement quantities of the other cells). The measurement quantity for a particular cell may depend on a RAT type of the cell. A standard for the RAT type may define a measurement quantity used for that RAT type. Generally, signal qualities such as a signal strength, signal to interference ratio, or signal to noise ratio may be used as a measurement quantity. Example measurement quantities include: common pilot channel (CPICH) energy to noise ratio (Ec/No), CPICH received signal code power (RSCP), GSM Carrier RSSI, E-UTRA RSRP, and E-Utra RSRQ.

The timer continuation component 34 may include means or be configured to continue a timer such as the first timer component 24 or the second timer component 26 when the timer would otherwise be reset, such as during a cell change procedure. The timer may be reset to a zero value or to some other default starting value. Continuing to run one of the timer components 24, 26 may include deciding to make no changes to the timer. For example, timer continuation component 34 may block a reset command for first timer component 24. In another aspect, a timer continuation component 34 may continue to run one of the timer components 24, 26 by copying a current value of the timer component to a new timer component. For example, the UE may start new timers based on a neighbor cell list before determining that the new neighbor cells are common neighbor cells corresponding to existing timers. The current value may be a time left to run until expiration or a time that the timer component has already run. For example, if the timer component 24 is set to run for 2 seconds, but a handover to another cell occurs after 1 second, timer continuation component 34 may continue to run the timer component 24 by starting a new timer component with a length of 1 second. As another example, the timer continuation component may set a current value of a new 2 second timer to 1 second and allow the timer to run for the remaining 1 second. It should be appreciated that processing operations may consume a certain amount of time which may or may not affect the duration of a timer component 24 depending on implementation.

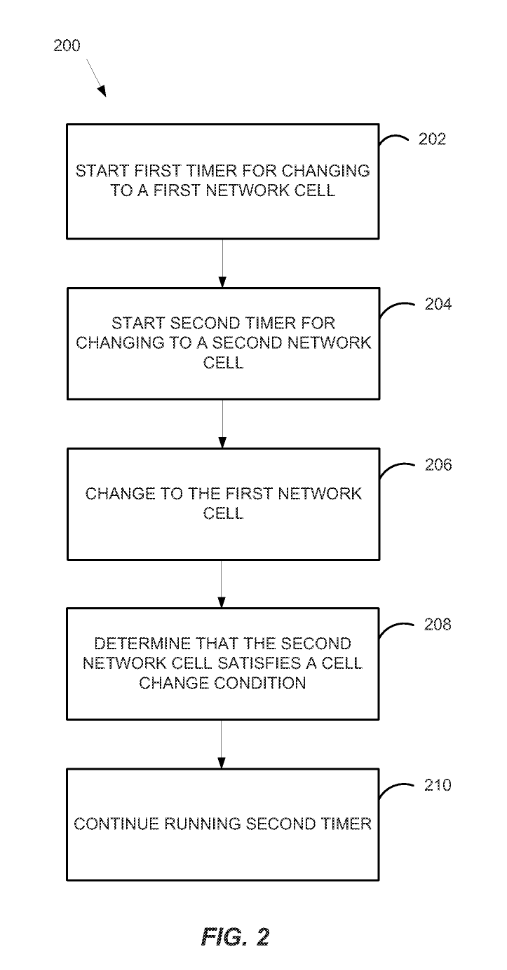

FIG. 2 is a flowchart illustrating a method 200 of cell selection. Referring to FIG. 1, in an operational aspect, a UE 12 may perform various aspects of a method 200 for cell selection. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 202, the method 200 includes starting a first timer for changing to a first network cell. For example, the first timer component 24 may start running when a first network cell, such as intra-frequency cell 18, satisfies a cell change condition. While the first timer component 24 is running, the cell change condition may be regularly checked by condition evaluating component 32 to ensure that the first network cell continues to satisfy the cell change condition. If the first network cell no longer satisfies the cell change condition, the first timer may be stopped and reset.

At block 204, the method 200 includes starting a second timer for changing to a second network cell. For example, the second timer component 26 may start running when a second network cell, such as inter-RAT cell 22, satisfies a cell change condition. While the second timer component 26 is running, the cell change condition may be regularly checked by condition evaluating component 32 to ensure that the second network cell continues to satisfy the cell change condition. If the second network cell no longer satisfies the cell change condition, the second timer may be stopped and reset. The cell change condition for the second network cell may be different than the cell change condition for the first network cell. For example, if the second network cell has a different RAT type than the first network cell, the cell change condition may be specific for the RAT type of the second network cell. The duration of the second timer component 26 may also be different than the duration of the first timer component 24. The duration of the timer may be based on a scaling factor for the type of cell change. For example, an intra-frequency cell change may have a shorter timer than an inter-RAT cell change.

At block 206, the method 200 includes changing to the first network cell when the first timer component 24 expires. The cell change component 30 may change the UE 12 to the first network cell 18 by performing either a handover or a cell reselection procedure. The cell change component 30 may initiate a handover by sending a measurement report indicating that the first cell has satisfied a cell change condition. A nodeB or other network component may determine whether to handover the UE 12 to the first network cell 18. In the case of reselection, the cell change component 30 may begin camping on the first network cell 18.

At block 208, the method 200 includes determining that the second network cell 22 satisfies a cell change condition. The cell change condition may be provided by the first network cell 18 and evaluated by the condition evaluating component 32 of the UE 12. The cell change condition may be the same as or different than the cell change condition satisfied when the second timer component 26 was started. For example, if the first network cell 18 has a same RAT type as a previous network cell 16, the cell change condition may remain the same. If, however, the first network cell has a different RAT type or a different frequency, the cell change condition for the second network cell 22 may change. The cell change condition may be provided by a measurement control message sent by the first network cell 18. The condition evaluating component 32 may process the neighbor list to extract the cell change condition.

At block 210, the method 200 includes continuing to run the second timer component 26 in response to determining that the second network cell satisfies the cell change condition. The timer continuation component 34 may continue to run the second timer component 26 by determining not to reset the timer after the change to the first network cell 18. In an aspect, the timer continuation component 34 may copy the current value of the second timer component 26 to a new timer. Continuing to run the second timer component 26 may allow the second timer to expire sooner than if the second timer were reset such that the UE may change to the cell 22.

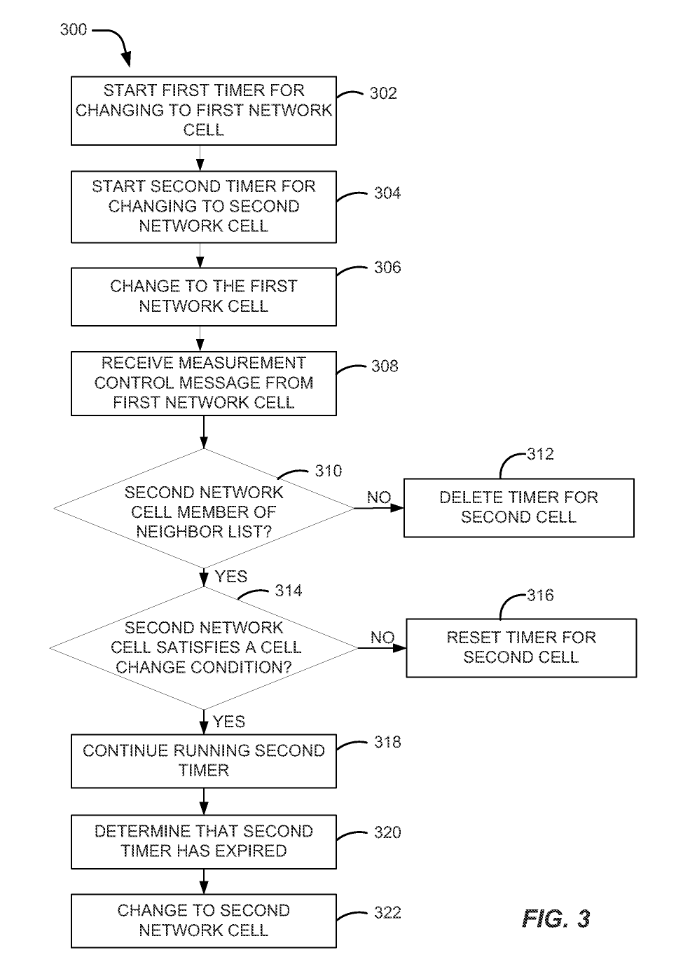

FIG. 3 is a flowchart illustrating another method 300 of cell selection. Referring to FIG. 1, in an operational aspect, a UE 12 (FIG. 1) may perform an aspect of a method 300 for cell selection. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 302, the method 300 includes starting a first timer component 24 for changing to a first network cell. The first timer component 24 may start when the first network cell 18 satisfies a cell change condition. While the timer is running, the cell change condition may be regularly checked by condition evaluating component 30 to ensure that the first network cell 18 continues to satisfy the cell change condition. If the first network cell 18 no longer satisfies the cell change condition, the first timer component 24 may be stopped and reset.

At block 304, the method 300 includes starting a second timer component 26 for changing to cell 22. The second timer component 26 may start when the second network cell 22 satisfies a cell change condition. While the second timer component 26 is running, the condition evaluating component 32 may regularly check the cell change condition to ensure that the cell 22 continues to satisfy the cell change condition. If the cell 22 no longer satisfies the cell change condition, the second timer component 26 may be stopped and reset. The cell change condition for the cell 22 may be different than the cell change condition for the first network cell 18. For example, if the cell 22 has a different RAT type than the first network cell 18, the cell change condition may be specific for the RAT type of the cell 22.

At block 306, the method 300 includes changing to the first network cell 18 when the first timer component 24 expires. The cell change component 30 may change UE 12 to the first network cell 18 by performing either a handover or a cell reselection. The cell change component 30 may initiate a handover by sending a measurement report indicating that the first cell has satisfied a cell change condition. A network node may determine whether to handover the UE 12 to the first network cell 18. In the case of reselection, the UE 12 may begin camping on the first network cell 18.

At block 308, the method 300 includes receiving a measurement control message from the first network cell 18. The measurement control message may include a neighbor cell list (also referred to simply as a neighbor list). The measurement control message may also define cell change criteria for individual neighbor cells or groups of neighbor cells. The measurement control message may indicate a measurement quantity for each neighbor cell that may be used in the cell change criteria. The measurement control message may also include one or more scaling factors that may affect the duration of the timer component 26.

At block 310, the method 300 includes determining whether the second network cell 22 is a member of the neighbor cell list. The communication manager component 14 may compare a RAT type, cell identifier, or frequency of a new neighbor cell list received from the first network cell 18 with a neighbor cell list of the previous serving cell 16. In an aspect, the neighbor cell list may only include a RAT type and frequency for a RAT type such as LTE. The UE 12 may determine a cell identifier based on signals received on the frequency associated with the neighbor cell. If the second network cell matches a cell in the new neighbor cell list, communication manager component 14 may determine that the second network cell 22 is a common neighbor cell. If the second network cell is a common neighbor cell, the method 300 may proceed to block 314. If the second network cell is not a common neighbor cell, the method 300 may proceed to block 312.

At block 312, the timer continuation component 34 may delete or reset the second timer component 26 for the second network cell 22. Deleting a timer component may include resetting the timer component, disassociating the timer component and a cell, and/or reallocating the resources of the timer component. The timer may no longer be applicable because the second network cell 22 is no longer a neighbor cell to which the UE 12 may reselect.

At block 314, the method 300 includes determining whether the second network cell 22 satisfies a cell change condition. The cell change condition may be determined according to the measurement control message received at block 308. The second network cell may be measured according to a measurement quantity indicated in the measurement control message and compared to a measurement threshold. The second network cell 22 may also be compared to the first network cell 18 according to either priority or ranking as part of the cell change condition. For example, the new cell change condition may be satisfied if the measured quantity for the second network cell 22 exceeds a measurement threshold, and the second network cell 22 has a higher priority than the first network cell 18. If the second network cell 22 satisfies the cell change condition, the method 300 may proceed to block 318. If the second network cell 22 does not satisfy the cell change condition, the method 300 may proceed to block 316.

At block 316, the timer continuation component 34 may stop and reset the second timer component 26 for the second network cell 22. The second network cell 22 may have satisfied a cell change condition for only part of the time period required by the timer, so a reselection or handover procedure may not be initiated. The second timer component 26 may be restarted if conditions change such that the second network cell 22 satisfies the cell change criteria.

At block 318, the method 300 may include continuing to run the second timer component 26 for the second network cell. The timer continuation component 34 may continue to run the second timer component 26 rather than resetting the second timer component 26 after the change to the first network cell 18. In an aspect, continuing to run the second timer may include determining not to perform a step of deleting or resetting the second timer when the second timer would otherwise be reset. In another aspect, continuing to run the second timer may include starting or updating a new timer component based on the second timer. For example, timer continuation component 34 may start a third timer for a cell in a new neighbor cells list, then update the third timer with a current value of the second timer component when the condition evaluating component 32 determines that the second network cell 22 matches the cell in the new neighbor list.

In various embodiments, changing to the first network cell 18 may affect the length of the second timer component 26. For example, the measurement control message received in block 308 may change the length of the second timer component 26 by providing a new scaling factor that is different than a previous scaling factor. As another example, the first RAT type of the first network cell may be the same as the second RAT type of the second network cell such that the change from the first network cell to a second network cell is an intra-RAT change. Accordingly, the scaling factor applicable to the second network cell 22 may change. When the length of the second timer component 26 changes, the second timer component 26 may still continue to run from the current value at the time of the change. For example, a timer with a length of 2 seconds and a current value of 1 second may be changed to have a length of 1.5 seconds. The timer may continue to run for another 0.5 seconds. If a change in the length of a timer results in a current value greater than the length of the timer, the timer may immediately expire, or the timer may run for a minimum duration.

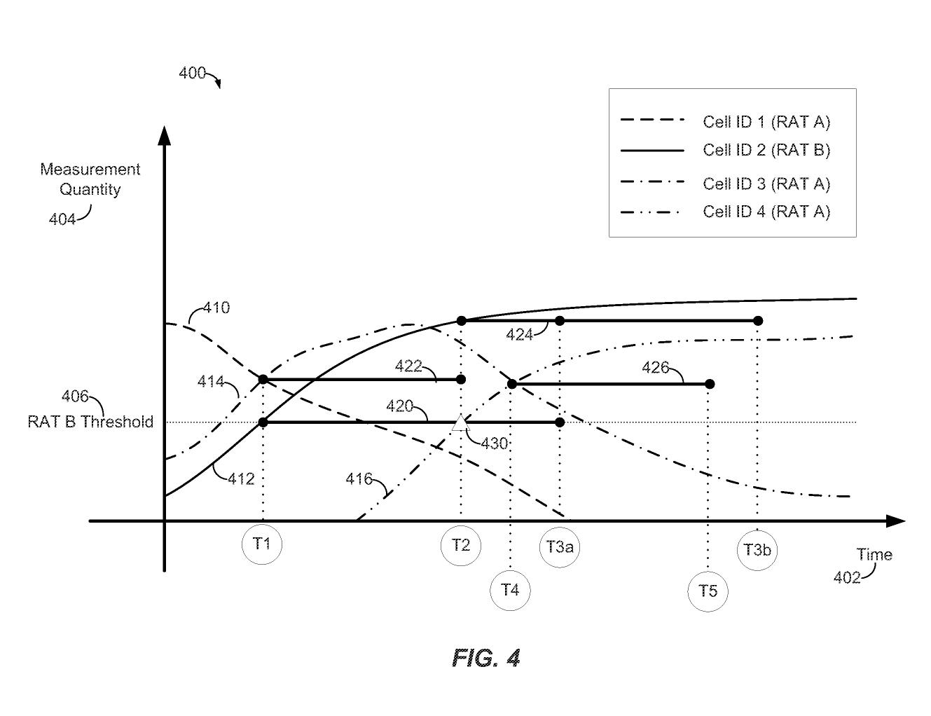

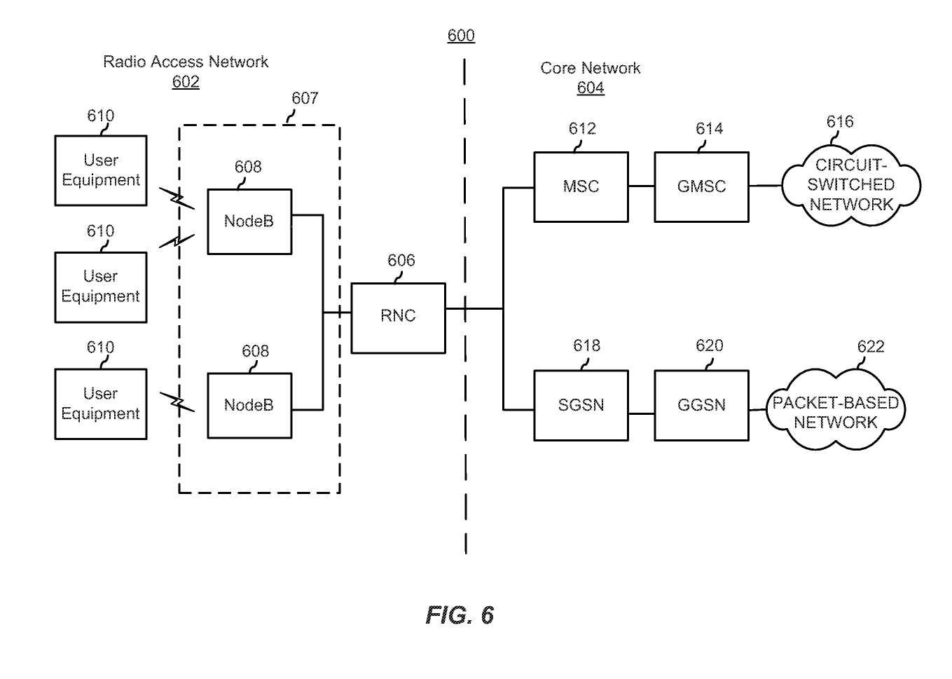

At block 320, the method 300 may include determining that the second timer component 26 has expired. The second timer component 26 may expire when a current value of the timer reaches the timer length. As discussed in further detail below regarding FIGS. 4 and 6, the second timer component 26 may expire before a third timer started after the change of cells for a third network cell 20 or a previous network cell 16. Accordingly, the second timer component 26 may expire in a high mobility scenario or a ping-pong scenario despite short timers for other network cells.

At block 322, the method 300 may include changing to the second network cell 22. In a handover, the cell change component 30 may initiate the change to the second network cell by sending a measurement report indicating that the second network cell 22 has satisfied a cell change condition. In a reselection, the cell change component 30 may cause the UE 12 to camp on the second network cell 22.

FIG. 4 is a timing diagram 400 illustrating a high mobility scenario. In the timing diagram 400, time 402 may be shown along a horizontal axis and a measurement quantity 404 may be shown along a vertical axis. The measurement quantities for cells 410, 412, 414, 416, which may each correspond to one of cells 16, 18, 20, or 22 (FIG. 1), are shown. Cell 410 may be the current serving cell. The measurement quantity 404 may vary depending on the RAT type of the measured cell. The current serving cell 410 may provide an indication of the measurement quantity 404 to be used for each RAT type. The current serving cell 410 may also provide a cell change condition based on the measurement quantity. For example, the measurement quantity 404 for a TD-SCDMA cell (RAT A) may be CPICH Ec/No or CPICH RSCP. The cell change condition for TD-SCDMA cell may be based on a ranking among the cells. As another example, the measurement quantity 404 for a GSM cell may be GSM Carrier RSSI. The cell change condition for changing to an LTE cell may be based on the priority of the LTE RAT and a minimum RAT B threshold 406. As will be described in further detail below, the current serving cell 410 may also provide scaling factors that affect the timer duration for each RAT type. In particular, the current serving cell 410 may provide an intra-frequency scaling factor, an inter-frequency scaling factor, and/or an inter-RAT scaling factor.

In a high mobility scenario, a UE (e.g. UE 12 of FIG. 1) may be moving quickly such that the measurement quantities from various cells change frequently. The UE 12 may initially be served by cell 410 and may be actively monitoring signals received from cells 412 and 414 in an active set or neighbor list.

At time T1, cells 412 and 414 may each satisfy a respective cell change condition. For example, the measured quantity for cell 412 may exceed the RAT B threshold, and the measured quantity for cell 414 may exceed the measured quantity for cell 410 and therefore cell 414 may outrank cell 410. The UE 12 may start a respective time-to-trigger (TTT) or reselection timer (T-reselection) based on the connection status of the UE when each cell satisfies a cell change condition. Each timer may correspond to one of the timer components 24, 26. A timer 420 for cell 412 may be set to expire at time T3a. A timer 422 for cell 414 may be set to expire at time T2. The different lengths or durations of the timers may be due to different scaling factors such as an intra-frequency scaling factor and an inter-RAT scaling factor.

At time T2, the timer 422 may expire and the UE 12 may initiate a handover or reselection procedure resulting in a serving cell change to cell 414, which may become the active serving cell. Cell 414 may send a measurement control message or cell information list identifying new neighbor cells, measurement quantities, cell change conditions, and/or scaling factors. In conventional cell selection methods, a UE may discard or reset all running timers when changing cells. Accordingly, timer 420 may be typically reset. Because cell 412 remains above the RAT B threshold 406, the timer 420 may also be immediately restarted as timer 424, which is set to expire at time T3b. The cell information list may include a new neighbor cell 416.

At time T4, the new neighbor cell 416 may satisfy a cell change condition because the measurement quantity 404 of cell 416 exceeds the measurement quantity 404 of current serving cell 414. The UE 12 may start a timer 426, which is set to expire at time T5. Once again, due to the shorter timer for the intra-frequency handover or reselection, the timer 426 may expire before the timer 424.

At time T5, the timer 426 may expire and the UE 12 may initiate a handover or reselection procedure resulting in a serving cell change to cell 416, which may become the active serving cell. Once again, the timer 424 may be reset during the handover or reselection procedure. In a high-mobility scenario, the frequent changing of inter-frequency cells may result in delaying or preventing a handover or reselection to a higher priority inter-RAT cell.

The UE 12 may prevent delays in changing to the higher-priority inter-RAT cell by selectively continuing to run a timer 420 for the inter-RAT cell. At time T2, during the handover or reselection procedure, the UE 12 may determine 430 whether to continue to run timer 420 based on a new neighbor list and measured parameters. In an alternative embodiment, the UE 12 may start or update new timer 424 with a current value of timer 420 such that timer 424 expires at time T3a. In either case, if the UE 12 continues to run timer 420, the timer 420 may expire at time T3a and a handover or reselection procedure to cell 412 may occur. Thus, the UE 12 may change to a higher priority cell 412 more quickly in a high-mobility scenario.

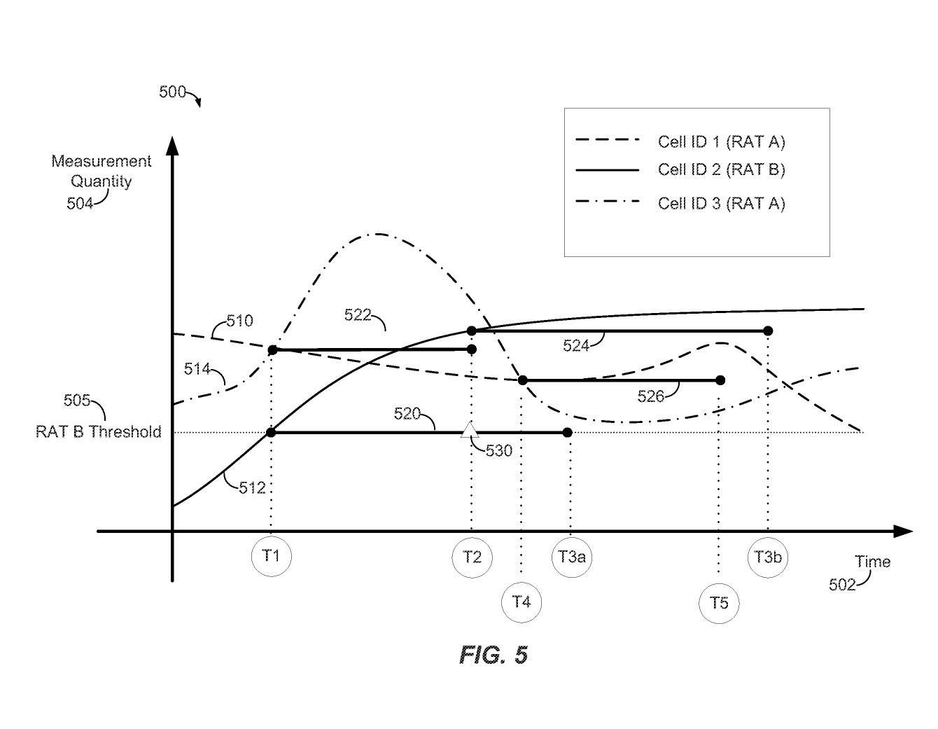

FIG. 5 is a timing diagram 500 illustrating a ping-pong scenario. The timing diagram 500 may be similar to timing diagram 500. In a ping-pong scenario, two cells may have similar measurement quantities 504 that fluctuate causing rapid changes in the best cell for a UE (e.g. UE 12 in FIG. 1) and frequent cell changes. The UE 12 may initially be served by cell 510 and may be actively monitoring signals received from cells 512 and 514 in an active set or neighbor list. The cells 510, 512, 514 may each correspond to one of the cells 16, 18, 20, or 22 (FIG. 1).

Similar to the high-mobility scenario, the cells 512 and 514 may satisfy a cell change criteria and the UE 12 may change to cell 514 when the timer 522 expires before timer 520 at time T2. In the ping-pong scenario, the original serving cell 510, rather than a new cell, may then satisfy the cell change criteria at time T4. Accordingly, the UE 12 may change back and forth between cells 510 and 514 as the relative values of measurement quantities 504 change frequently. In an aspect, the change in the values of measurement quantities of cells 510 and 514 may be due, in part, to the UE 12 or another UE. The UE 12 may be prevented from changing to cell 512 even if the other RAT type has a higher priority because of the frequent intra-frequency changes between cells 510 and 512.

The UE 12 may prevent delays in changing to the higher-priority inter-RAT cell by selectively continuing to run a timer 520 for the inter-RAT cell. At time T2, during the handover or reselection procedure, the UE 12 may determine 530 whether to continue to run timer 520 based on a new neighbor list and measured parameters. In an alternative embodiment, UE 12 may start or update new timer 524 with a current value of timer 520 such that timer 524 expires at time T3a. In either case, if the UE 12 continues to run timer 520, the timer 520 may expire at time T3a and a handover or reselection procedure to cell 512 may occur. Thus, the UE 12 may be able to change to the higher priority cell 512. Moreover, changing to the higher priority cell 512 may reduce the number or frequency of cell changes because the cells 510 and 514 may not satisfy a cell change condition provided by cell 512.

Turning now to FIG. 6, a block diagram is shown illustrating an example of a telecommunications system 600. The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system employing a TD-SCDMA standard. In this example, the UEs 610 may each correspond to the UE 12 (FIG. 1) and include a communication manager component 14. In this example, the UMTS system includes a (radio access network) RAN 602 (e.g., UTRAN) that provides various wireless services including telephony, video, data, messaging, broadcasts, and/or other services. The RAN 602 may be divided into a number of Radio Network Subsystems (RNSs) such as an RNS 607, each controlled by a Radio Network Controller (RNC) such as an RNC 606. For clarity, only the RNC 606 and the RNS 607 are shown; however, the RAN 602 may include any number of RNCs and RNSs in addition to the RNC 606 and RNS 607. The RNC 606 is an apparatus responsible for, among other things, assigning, reconfiguring and releasing radio resources within the RNS 607. The RNC 606 may be interconnected to other RNCs (not shown) in the RAN 602 through various types of interfaces such as a direct physical connection, a virtual network, or the like, using any suitable transport network.

The geographic region covered by the RNS 607 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 608 are shown; however, the RNS 607 may include any number of wireless Node Bs. The Node Bs 608 provide wireless access points to a core network 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 610 are shown in communication with the Node Bs 608. The downlink (DL), also called the forward link, refers to the communication link from a Node B to a UE, and the uplink (UL), also called the reverse link, refers to the communication link from a UE to a Node B.

The core network 604, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 604 supports circuit-switched services with a mobile switching center (MSC) 612 and a gateway MSC (GMSC) 614. One or more RNCs, such as the RNC 606, may be connected to the MSC 612. The MSC 612 is an apparatus that controls call setup, call routing, and UE mobility functions. The MSC 612 also includes a visitor location register (VLR) (not shown) that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR to determine the UE's location and forwards the call to the particular MSC serving that location.

The core network 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard GSM circuit-switched data services. The GGSN 620 provides a connection for the RAN 602 to a packet-based network 622. The packet-based network 622 may be the Internet, a private data network, or some other suitable packet-based network. The primary function of the GGSN 620 is to provide the UEs 610 with packet-based network connectivity. Data packets are transferred between the GGSN 620 and the UEs 610 through the SGSN 618, which performs primarily the same functions in the packet-based domain as the MSC 612 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 608 and a UE 610, but divides uplink and downlink transmissions into different time slots in the carrier.

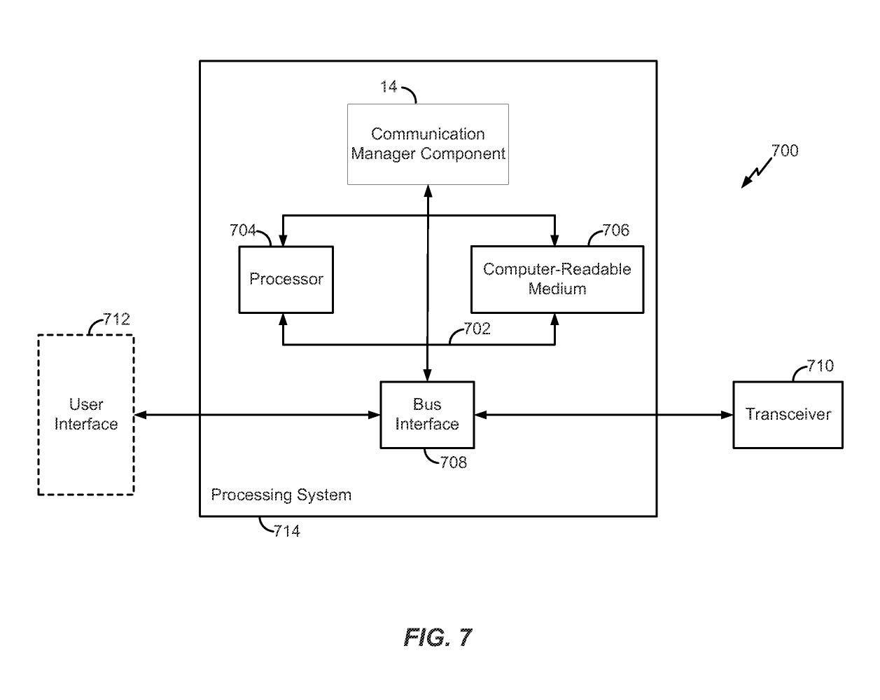

FIG. 7 is a block diagram conceptually illustrating an example of a hardware implementation for an apparatus 700 employing a processing system 714. The apparatus 700 may correspond to the UE 12 (FIG. 1) and include a communication manager component 14. In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors, represented generally by the processor 704, and computer-readable media, represented generally by the computer-readable medium 706. The bus also may link communication manager component 14 to processor 604, and computer-readable medium 606. In an aspect, rather than being a separate entity, the communication manager component 14 may be implemented by processor 604 operating in conjunction with computer-readable medium 606.

The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described infra for any particular apparatus. The computer-readable medium 706 may also be used for storing data that is manipulated by the processor 704 when executing software.

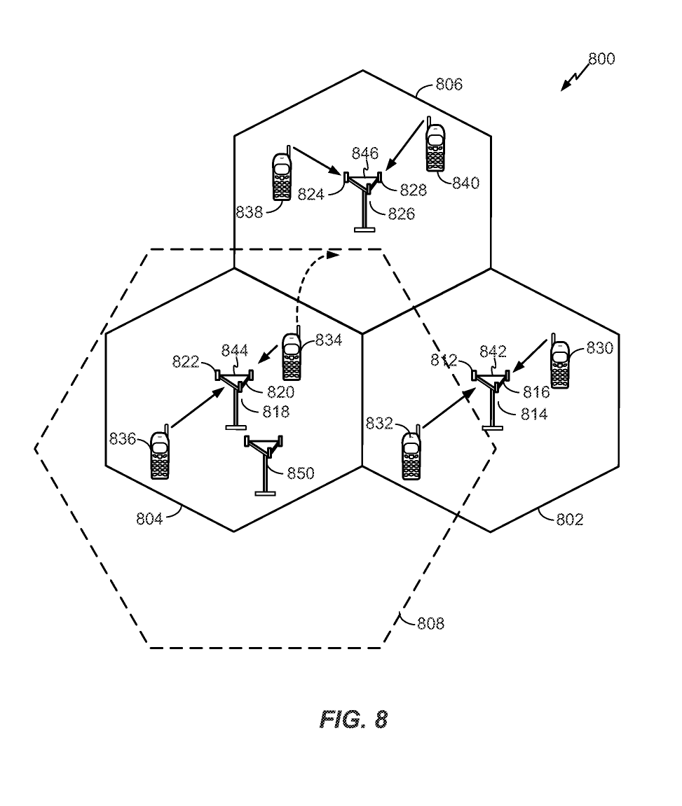

Referring to FIG. 8, an access network 800 in a UTRAN architecture is illustrated. The access network 800 may provide wireless communication access for UEs 830, 832, 834, 836, 838, 840, which may each be an example of the UE 12 in FIG. 1. The multiple access wireless communication system includes multiple cellular regions (cells), including cells 802, 804, 806, and 808 each of which may include one or more sectors. The presently described apparatus and method may allow the UE 834, for example, to change between cells 802, 804, 806, and 808 particularly in a high mobility or ping-pong scenario. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804, 806, and 808 may include several wireless communication devices, e.g., UEs which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a core network 604 (see FIG. 6) for all the UEs 830, 832, 834, 836, 838, 840 in the respective cells 802, 804, and 806.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 606 (see FIG. 6), or at another suitable node in the wireless network. For example, during a call with the source cell 804, or at any other time, the UE 834 may monitor various parameters of the source cell 804 as well as various parameters of neighboring cells such as cells 806 and 802. In particular, the UE 834 may monitor cells included in a neighbor cell list. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set).

The modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system. In an aspect of the present disclosure, the modulation, frequency, multiple access scheme, and wireless communication standard may define a radio access technology (RAT) type. More generally, a RAT or RAT type may refer to a particular combination of frequency and wireless communication standard.

A radio access network 800 may include one or more cells 808 that use a different RAT type than current serving cell 804. For example, cell 808 may be an LTE cell provided by base station 850. The coverage area of cell 808 may overlap with the coverage area of one or more of cells 802, 804, and 806. UEs 830, 832, 834, 836, 838, and 840 may each be configured as described above regarding UE 12 in FIG. 1 to allow the UE to select a best cell according to a measurement quantity, priority and ranking of the cells 802, 804, 806, and 808.

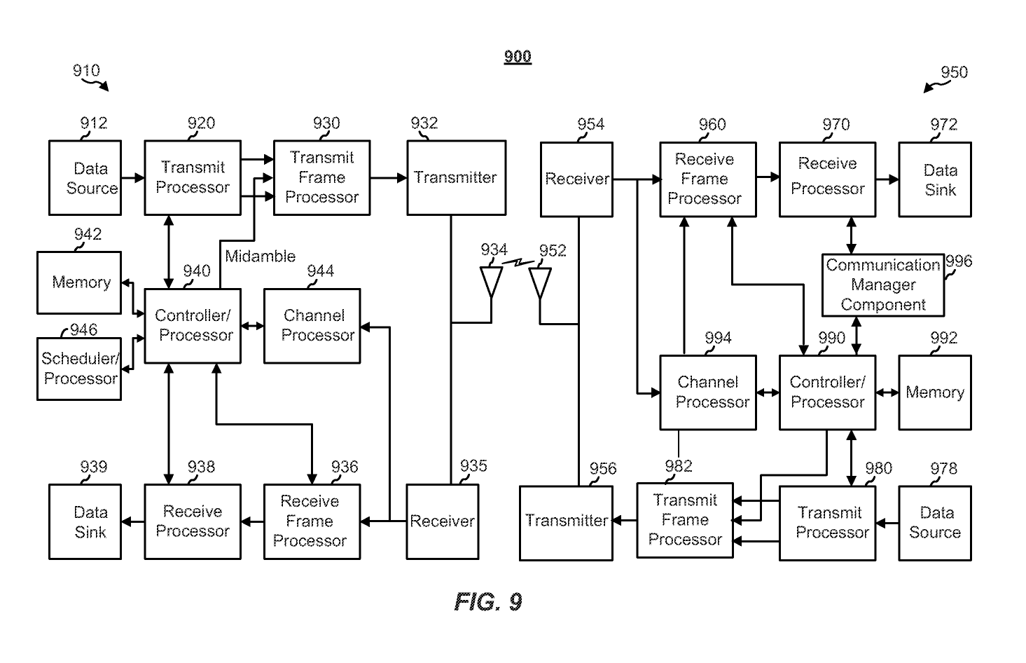

FIG. 9 is a block diagram of a Node B 910 in communication with a UE 950 in a RAN 900, where the RAN 900 may be the RAN 602 in FIG. 6, the Node B 910 may be the Node B 608 in FIG. 6, and the UE 650 may be the UE 12 in FIG. 1. The UE 650 may include a communication manager component 996 for determining whether UE 950 should move to a cell other than the cell provided by Node B 910. The communication manager component 996 may correspond to the communication manager component 14 (FIG. 1).

In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback contained in the midamble from the UE 950. The symbols generated by the transmit processor 920 are provided to a transmit frame processor 930 to create a frame structure. The transmit frame processor 930 creates this frame structure by multiplexing the symbols with a midamble from the controller/processor 940, resulting in a series of frames. The frames are then provided to a transmitter 932, which provides various signal conditioning functions including amplifying, filtering, and modulating the frames onto a carrier for downlink transmission over the wireless medium through smart antennas 934. The smart antennas 934 may be implemented with beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides the midamble to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with a midamble from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides the midamble to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

A communication manager component 996 may be used to determine whether UE 950 should move to a cell other than the cell provided by Node B 910. The communication manager component 996 may receive signal information from receive processor 970 including reference signal information for other cells such as measurements of the pilot channels. The communication manager component 996 may determine measurement quantities, priorities and rankings of the other cells. The communication manager component 996 may also determine whether cell selection criteria have been satisfied for any of the other cells and manage timers when the selection criteria are satisfied. The communication manager component 996 may selectively reset or continue to run the timers when the UE 950 changes cells.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
starting a first timer for changing to a first network cell with a first radio access technology (RAT);
starting a second timer for changing to a second network cell with a second RAT;
changing to the first network cell when the first timer expires;
determining that the second network cell satisfies a cell change condition; and
continuing to run the second timer after the change to the first network cell in response to the second network cell satisfying the cell change condition.

2. The method of claim 1, further comprising:
determining that the second timer has expired and
changing to the second network cell in response to the second timer expiring.

3. The method of claim 1, further comprising:
receiving, from the first network cell, a neighbor cell list; and
determining that the second network cell is a member of the neighbor cell list.

4. The method of claim 3, wherein the neighbor cell list comprises a frequency and a cell identifier of at least one neighbor cell, and wherein determining that the second network cell is a member of the neighbor cell list comprises matching a frequency and a cell identifier of the second network cell to the frequency and cell identifier of the at least one neighbor cell.

5. The method of claim 3, wherein the neighbor cell list comprises a RAT type and frequency of at least one neighbor cell, and wherein determining that the second network cell is a member of the neighbor cell list comprises:
receiving a cell identifier of the at least one neighbor cell from the at least one neighbor cell; and
matching a frequency and a cell identifier of the second network cell to the received frequency and cell identifier of the at least one neighbor cell.

6. The method of claim 1, further comprising:
receiving, from the first network cell, a neighbor cell list;
determining that the second network cell is not a member of the neighbor cell list; and
resetting the second timer in response to the second network cell not being a member of the neighbor cell list.

7. The method of claim 1, wherein the cell change condition is satisfied when the RAT of the second network cell has a higher priority than the RAT of the first network cell or the second network cell is ranked higher than the first network cell.

8. The method of claim 1, further comprising:
starting a third timer for changing to a third network cell after changing to the first network cell, the third network cell having the same RAT as the first network cell,
wherein a duration of the second timer is longer than a duration of the third timer and the second timer expires before the third timer.

9. The method of claim 1, further comprising:
starting a third timer for changing to a previous network cell after changing to the first network cell,
wherein a duration of the second timer is longer than a duration of the timer and the second timer expires before the third timer.

10. The method of claim 1, further comprising:
receiving scaling factor information from the first network cell; and
adjusting a duration of the second timer based on the scaling factor information.

11. The method of claim 1, wherein continuing to run the second timer after the change to the first network cell comprises starting a third timer for changing to the second network cell, wherein a duration of the third timer is based on a current value of the second timer at the time of the change to the first network cell.

12. An apparatus for wireless communication, comprising:
means for starting a first timer for changing to a first network cell with a first radio access technology (RAT);
means for starting a second timer for changing to a second network cell with a second RAT;
means for changing to the first network cell when the first timer expires;
means for determining that the second network cell satisfies a cell change condition; and
means for continuing to run the second timer after the change to the first network cell in response to the second network cell satisfying the cell change condition.

13. An apparatus for wireless communication, comprising:
at least one processor; and
a memory coupled to the at least one processor,
wherein the at least one processor is configured to:
start a first timer for changing to a first network cell with a first radio access technology (RAT);
start a second timer for changing to a second network cell with a second RAT;
change to the first network cell when the first timer expires;
determine that the second network cell satisfies a cell change condition; and
continue to run the second timer after the change to the first network cell in response to the second network cell satisfying the cell change condition.

14. The apparatus of claim 13, wherein the processor is further configured to:
receive, from the first network cell, a neighbor cell list; and
determine that the second network cell is a member of the neighbor cell list.

15. The apparatus of claim 14, wherein the neighbor cell list comprises a RAT type and a frequency of at least one neighbor cell, wherein determining that the second network cell is a member of the neighbor cell list comprises: receiving a cell identifier of the at least one neighbor cell from the at least one neighbor cell and matching the frequency and cell identifier of the second network cell to the received frequency and cell identifier of the at least one neighbor cell.

16. The apparatus of claim 13, wherein the processor is further configured to:
receive, from the first network cell, a neighbor cell list;
determine that the second network cell is not a member of the neighbor cell list; and
delete the second timer in response to the second network cell not being a member of the neighbor cell list.

17. The apparatus of claim 13, wherein the cell change condition is satisfied when the RAT of the second network cell has a higher priority than the RAT of the first network cell or the second network cell is ranked higher than the first network cell.

18. The apparatus of claim 13, wherein the processor is further configured to:
start a third timer for changing to a third network cell after changing to the first network cell, the third network cell having the same RAT as the first network cell,
wherein a duration of the second timer is longer than a duration of the third timer and the second timer expires before the third timer.

19. The apparatus of claim 13, wherein the processor is further configured to:
receive scaling factor information from the first network cell; and
adjust a duration of the second timer based on the scaling factor information.

20. The apparatus of claim 1, wherein continuing to run the second timer after the change to the first network cell comprises running a third timer for changing to the second network cell from a current value of the second timer at the time of the change to the first network cell.
